(19) United States
(12) Patent Application Publication
(10) Pub. No.: US 2014/0185576 A1
(43) Pub. Date: Jul. 3, 2014

(54) PDSCH ASSIGNMENT INDICATION FOR FDD SCELL ACK/NACK TRANSMISSION

(71) Applicants: Haipeng Lei, Beijing (CN); Kodo Shu, Beijing (CN)

(72) Inventors: Haipeng Lei, Beijing (CN); Kodo Shu, Beijing (CN)

(73) Assignee: Nokia Corporation, Espoo (FI)

(21) Appl. No.: 14/237,662

(22) PCT Filed: Aug. 11, 2011
(86) PCT No.: PCT/CN2011/078261

§ 371 Date: Feb. 7, 2014

(51) Int. Cl. H04L 5/00

(52) U.S. Cl. CPC H04L 5/0055
USPC 370/329

(57) ABSTRACT

A pico network node sends to a UE an allocation of physical downlink shared channel PDSCH subframes on the SCell. The allocation has control signaling indicating a number of the allocated PDSCH subframes that lie within a multiplexing window. The pico network node sends to the UE data on each of the allocated downlink subframes. The UE is also configured for a PCell with a macro network node not co-located with the pico. The UE determines from control signaling the number of PDSCH subframes that are allocated; and checks the determined number against PDSCH subframes it's received, to detect whether any allocated PDSCH subframe is missed. In an embodiment the control signaling is two bits per allocated downlink subframe as an assignment indication.

### TECHNICAL FIELD

This invention relates generally to signaling in radio networks having two or more cells communicating with a user equipment such as in a carrier aggregation arrangement, and more specifically relates to control signaling related to radio resource scheduling and acknowledgements/negative acknowledgments.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

ACK acknowledgment

BLER block error ratio or rate

CA carrier aggregation

CSI channel state information

DCI downlink control information

DL downlink (network towards UE)

DTX discontinuous transmission

eNB EUTRAN Node B

EUTRAN evolved UTRAN (also known as LTE or LTE-A)

LTE/-A long term evolution/long term evolution-advanced

MME mobility management entity

NACK negative acknowledgment

Node B base station

PAI PDSCH assignment indication

PCell primary cell/primary component carrier

PDCCH physical downlink control channel

PDSCH physical downlink shared channel

PRB physical resource block

PUSCH physical uplink shared channel

RF radio frequency

SCell secondary cell/secondary component carrier

SPS semi-persistent scheduling

TPC transmission power control

UCI uplink control information

UE user equipment

UL uplink (UE towards network)

UTRAN universal terrestrial radio access network

The LTE system is to provide significantly enhanced services by means of higher data rates and lower latency with reduced cost. In the LTE and other cellular radio systems the base station (termed an eNodeB or eNB in LTE) signals on the PDCCH the time-frequency resources (physical resource blocks) on the PDSCH and PUSCH which are allocated to a mobile terminal (UE). This scheduling technique allows advanced multi-antenna techniques like precoded transmission and multiple-input/multiple-output operation for the downlink shared data channel.

LTE is a heterogeneous network (sometimes termed HetNet), in which there are access nodes apart from the traditional base stations which operate at different power levels. For example, there may be privately operated nodes sometimes termed pico or femto nodes to which the conventional (macro) eNBs can offload traffic; there may be remote radio heads or repeaters to fill coverage holes, and there may be relay nodes which operate similar to the eNB which controls them but using a subset of the eNB's radio resources assigned to the relay node by the parent eNB.

LTE-A (expected in 3GPP Release 11) implements heterogeneous networks using carrier aggregation, where two or more component carriers spanning different frequency bands are aggregated into the same system. By example, there may be five component carriers which together cover the whole system bandwidth of 100 MHz and a given UE has two of those component carriers as active for itself. Each UE always has one PCell and may have one or more SCells, which may be in the licensed spectrum or in unlicensed spectrum such as the Industrial, Scientific and Medical (ISM) band. Any given SCell may have a full set of data and control channels (e.g., backwards compatible with 3GPP Release 8) or may carry only data channels (termed an extension carrier).

In a LTE-A heterogeneous network the same UE may be communicating with a macro eNB on the PCell and with a pico eNB on its SCell as shown at FIG. 1. For such an inter-site implementation of carrier aggregation, multiple component carriers are transmitted from multiple sites in the downlink and multiple component carriers are transmitted to multiple sites in uplink. Inter-site CA can provide dynamic multilayer traffic steering or offloading, enhance data rate in the overlapped coverage region of two/multiple cells or transmission points, and reduce handover overhead. Such a Macro-Pico usage is expected to be the most typical scenario when a UE is configured with two component carriers.

In case of inter-site CA, the UE needs to transmit the UCI that is relevant to the PCell and to the SCell, for example to report the periodic CSI of each cell, to feedback the ACKs/NACKs relating to the scheduled resources on the PDSCH of the PCell and on the PDSCH of the SCell, and to send scheduling requests. If the UE simultaneously transmits uplink control information on both carriers in the uplink (referred to as a dual-carrier UCI transmission) it may lead to high BLER of the transmitted UCI because of the UE's power limitations and also due to a large pathloss from the UE to the macro eNB. This makes it difficult to meet the guaranteed target BLER of 1% for ACK-to-NACK and of 0.1% for NACK-to-ACK transmissions.

Exemplary embodiments disclosed below are directed toward control signaling which enables the network and UE to meet the above (or other) BLER targets, particularly in a single-carrier UCI transmission scenario.

### BRIEF DESCRIPTION OF THE DRAWINGS

FIG. 1 is a block diagram illustrating one exemplary radio environment and the relevant logical channels for implementing the invention in an LTE radio system. FIG. 1: illustration of typical inter-site CA (Macro-Pico case)

FIG. 2 illustrates mapping of DL to UL subframes on each of the PCell and on the SCell illustrating how the UE switches in the time domain between two UL carriers to transmit ACK/NACK for the corresponding downlink subframes.

FIG. 3 illustrates three different examples in which there are PDSCH assignment indications corresponding to each allocated subframe on the PDSCH of the SCell which the UE uses to detect whether there are any missed PDSCH subframes so as to properly generate ACK/NACK bits according to exemplary embodiments.

FIGS. 4-5 are flow diagrams illustrating a method, and actions taken by an apparatus, and the result of executing an embodied computer program from the perspective of the UE and from the wireless network(s) respectively, according to the exemplary embodiments of the invention.

FIG. 6 is a schematic block diagram showing various electronic devices/apparatus suitable for implementing exemplary embodiments of the invention detailed herein.

### SUMMARY

In a first exemplary aspect of the invention there is an apparatus which includes at least one processors and at least one memory containing computer program code. The at least one memory and the computer program code are configured to, with the at least one processor, to cause the apparatus to at least: determining from the received downlink control signaling a number of downlink subframes within a multiplexing window that are allocated for a UE; and check the determined number against the received downlink subframes within the multiplexing window to detect whether or not any allocated downlink subframe within the multiplexing window is missed. In this case the control signaling and the corresponding downlink subframes are received on a SCell from a Pico eNB and the UE is also configured for a PCell with Macro eNB not co-located with the Pico eNB.

In a second exemplary aspect of the invention there is a method comprising: determining from the received downlink control information a number of downlink subframes within a multiplexing window that are allocated for a UE; and checking the determined number against downlink subframes received within the multiplexing window to detect whether or not any allocated downlink subframe within the multiplexing window are missed. Also in this case the control signaling and the corresponding downlink subframe are received on a SCell from a Pico eNB and the UE is also configured for a PCell with a Macro eNB not co-located with the Pico eNB.

In a third exemplary aspect of the invention there is a computer readable memory storing a program of instructions which when executed by at least one processor result in actions comprising: determining from the received control information a number of downlink subframes within a multiplexing window that are allocated for a UE; and checking the determined number against downlink subframes received within the multiplexing window to detect whether or not any allocated downlink subframe within the multiplexing window is missed. Also in this embodiment the control signaling and the downlink subframe are received on a SCell from a Pico eNB and the UE is also configured for a PCell with a Macro eNB not co-located with the Pico eNB

In a fourth exemplary aspect of the invention there is a method comprising: sending from Pico eNB to a user equipment an allocation of downlink subframes on a secondary cell, in which the allocation further comprises control signaling which indicates a number of the allocated downlink PDSCH subframes that lie within a multiplexing window; and sending from the Pico eNB to the UE on each of the allocated downlink subframes. In this case the user equipment is further configured for a PCell with a Macro eNB not co-located with the Pico eNB.

In a fifth exemplary aspect of the invention there is an apparatus which includes at least one processors and at least one memory including computer program code. The at least one memory and the computer program code are configured to, with the at least one processor, to cause the apparatus to at least: send to a user equipment an allocation of downlink subframes on a secondary cell, in which the allocation further comprises control signaling which indicates a number of the allocated downlink subframes that lie within a multiplexing window; and send to the user equipment data on each of the allocated downlink subframes. In this case the user equipment is further configured for a PCell with a Macro eNB not co-located with the apparatus.

In a sixth exemplary aspect of the invention there is a computer readable memory storing a program of instructions which when executed by at least one processor result in actions comprising: sending from a Pico eNB to a user equipment an allocation of downlink subframes on a secondary cell, in which the allocation further comprises control signaling which indicates a number of the allocated downlink subframes that lie within a multiplexing window; and sending from the Pico eNB to the user equipment data on each of the allocated downlink subframes. In this case the user equipment is further configured for a PCell with a Macro eNB not co-located with the Pico eNB.

### DETAILED DESCRIPTION

Seemingly, dual-carrier UCI transmissions can be made to satisfy the BLER targets that are detailed in the background section above simply by having the UE transmit all its ACKs/NACKs to one of the sites since there is a ready X2 interface between the macro and pico eNB. But then the UCI that is relevant for the other site needs to be forwarded to that site via that X2 interface. In practice this X2 forwarding may lead to about a delay of up to 20ms, meaning fast radio resource management cannot be adopted. The various UCIs need to be separately signaled on the PCell and on the SCell, which the UE can do by switching between the two component carriers in a time division multiplexing manner to send the UCI of each cell.

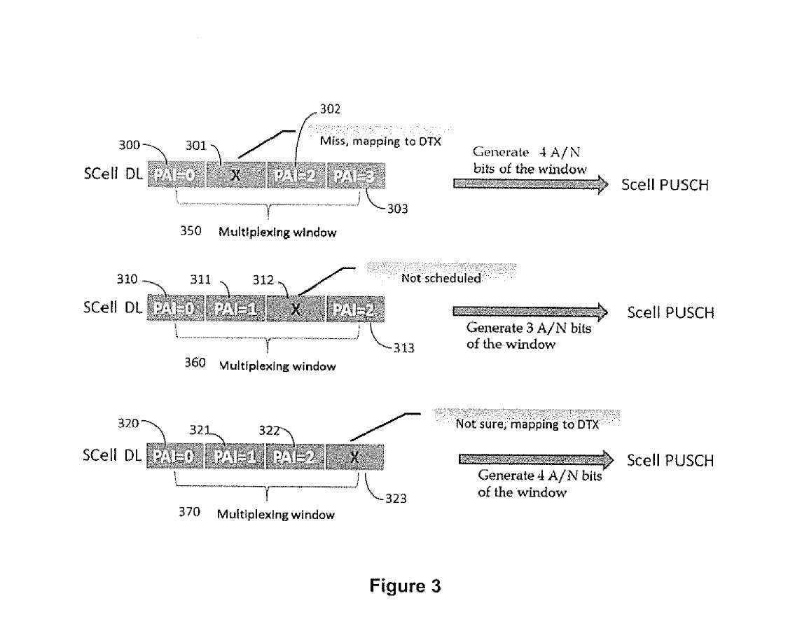

Such a time division switchover is shown by example at FIG. 2, which bears an “X” in various subframes to indicate that no UCI transmission can be carried in that subframe. This is called single-carrier UCI transmission compared to dual-carrier UCI transmission. For single-carrier UCI transmission in the case of inter-site carrier aggregation, since ACK/NACK bits of the PCell and the SCell are transmitted by switching between two component carriers in the time domain, some UL subframes on one component carrier may not be used to transmit its UCI.

FIG. 2 gives examples of this. In the PCell, if the UE is receiving a PDSCH in subframe 2 and 3 the UE would normally feedback the corresponding ACK/NACK respectively in uplink subframes 6 and 7 which are mapped by the dotted lines according to current LTE Releases 8, 9 and 10. However, for single-carrier UCI transmission, uplink subframe 6 and 7 cannot be occupied to transmit the UCI of the PCell, so the corresponding ACK/NACK of PDSCH in subframes 2 and 3 may be transmitted together in uplink subframe 8 which is mapped at FIG. 2 by a solid line. Similarly for the SCell, the conventional mapping shown by dotted lines from PDSCH subframes 0 and 1 to send the UCI in UL subframes 4 and 5 cannot be used in this single-carrier UCI scenario and so those ACKs/NACKs will be sent instead in UL subframe 6 mapped by the solid line.

FIG. 2 shows that in each cell, the number of UL subframes is smaller than the number of DL subframes from which they map so one UL subframe of each cell may carry ACK/NACK bits corresponding to multiple DL subframes of the same cell. It is convenient to arrange the many DL subframes which map to the single UL subframe to be consecutive DL subframes. In time domain division of LTE which have this many-to-one mapping, there is a downlink allocation indication of two bits contained in the downlink control information which is specific for any given DL assignment indication. In the frequency domain division of LTE there is no such field because there is only a one-to-one mapping between DL and UL. But in the frequency domain division if the UE never correctly reads on the PDCCH that it has an allocation on one of the PDSCH subframes, this many-to-one mapping prevents the eNB from recognizing if the UE missed that allocated DL subframe altogether. Therefore, when single-carrier based inter-site carrier aggregation is introduced for a UE operating according to frequency domain division in LTE, there needs to be a way to map the multiple ACK/NACK bits sent in the one UL subframe to its corresponding multiple DL subframes so that the UE and the eNB can know if the UE has missed any of the DL subframes. This is different from sending a NACK for a PDSCH that the UE knows is allocated to it but does not correctly receive; in this case the UE missed that it was even allocated that PDSCH but the eNB has no way to know absent the UE's ACK/NACK which in this case the UE will not send. Exemplary embodiments detailed below enable the eNB to detect whether any of those allocated downlink subframes are missed, which affects the total number of ACK/NACK bits the UE will send UL.

Currently LTE only supports co-site carrier aggregation (see for example 3GPP TS 36.213 v10.2.0) in which the PCell and all SCells for a given UE are configured for the same eNB. So for example with reference to FIG. 2, if a UE receives a downlink PDSCH in subframe n then the UE shall transmit the corresponding ACK/NACK in subframe n+4. This is a one-to-one mapping and so the eNB knows if there is a missing DL subframe if it gets neither an ACK nor a NACK in the mapped UL subframe. In conventional LTE there is no way for the eNB to know, for frequency domain division using inter-site carrier aggregation, whether there is a missing DL subframe since inter-site carrier aggregation uses a many-DL-subframe to one-UL-subframe mapping.

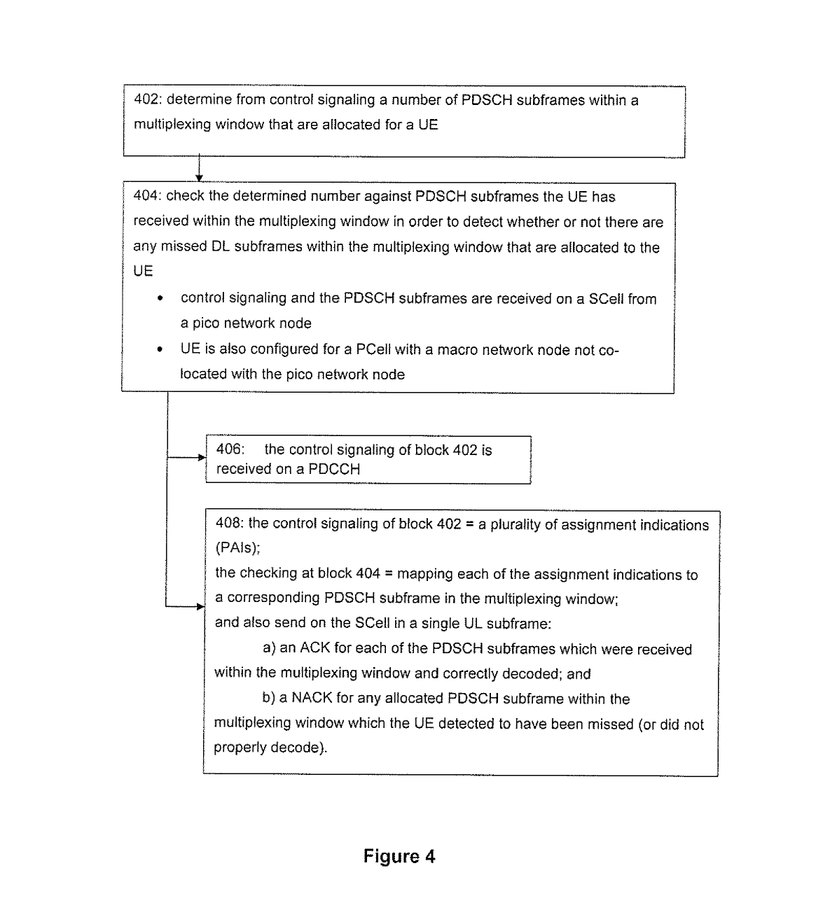

As described with reference to FIG. 2, in this scenario ACK/NACK bits from the same UE cannot be carried on two component carriers simultaneously. So in an exemplary embodiment all of the DL subframes allocated to the UE for which their respective ACKs and NACKs are to be sent in a single UL subframe are grouped into what is termed herein a multiplexing window (see FIG. 3). To inform the UE which subframes in any given multiplexing window are allocated to the UE, the eNB sends a downlink control indication in the form of an assignment indication which in the examples below is two bits for each DL subframe allocated to the UE. In one embodiment the PDSCH on the SCell is granted by an allocation sent by the pico eNB on the SCell itself, and the pico eNB also sends this/these assignment indications to the UE in the PDCCH which is also sent on the SCell. As will be detailed below, the UE can detect from the received assignment indications whether it has missed one of the DL subframes on the PDSCH which was allocated to it.

In an exemplary embodiment the bits used for the assignment indication for a given multiplexing window are re-used from the TPC bits which in conventional implementations of LTE are used to signal power control adjustments the UE is to make for its transmissions on the PUCCH. In a specific embodiment this re-use of the TPC bits to detect if there is a missing downlink PDSCH subframe is specifically for any of DCI formats 1/1A/1B/1D/2/2A/2C for SCell. This is possible because at least in the above frequency domain division scenario there is no PUCCH carried on the SCell (see for example 3GPP TS 36,213 Rel-10 v10.2.0), and so the re-use noted above will have no impact on the uplink power control for frequency domain division implementations of the LTE system.

In an exemplary embodiment the PDSCH assignment indication (termed in FIG. 3 as a PAI per allocated DL subframe) maps to the accumulative number of PDSCH(s) within the above-referenced multiplexing window, and the PAI is updated from subframe to subframe. In this exemplary embodiment the PAI value per PDSCH subframe is numbered from 0 to one-less than the size of the multiplexing window (window size −1), and the multiplexing window spans only consecutive subframes of the PDSCH. The UE can then check that all of the received PAIs contained in the PDCCH corresponding to PDSCH subframes are in a consecutive order; if they are not the UE shall know which downlink subframe is missed.

The table below gives one specific non-limiting example of how the meaning of the four possible different values of the two bits of a given PAI contained in the downlink control information for frequency domain division can be interpreted. While these examples use a multiplexing window of size four and two bits for the per-DL subframe PAI, these are not limiting to the invention detailed herein. The table below uses overlapped subframe numbers for a given two-bit PAI value to support up to nine DL subframes in a multiplexing window (since the eNB knows how many PDSCH subframes it sends).

| PAI | | PDSCH subframe number within |
|---|---|---|
| MSB, LSB | Value | multiplexing window |
| 0, 0 | 0 | 0 or 4 or 8 |
| 0, 1 | 1 | 1 or 5 or 9 |
| 1, 0 | 2 | 2 or 6 |
| 1, 1 | 3 | 3 or 7 |

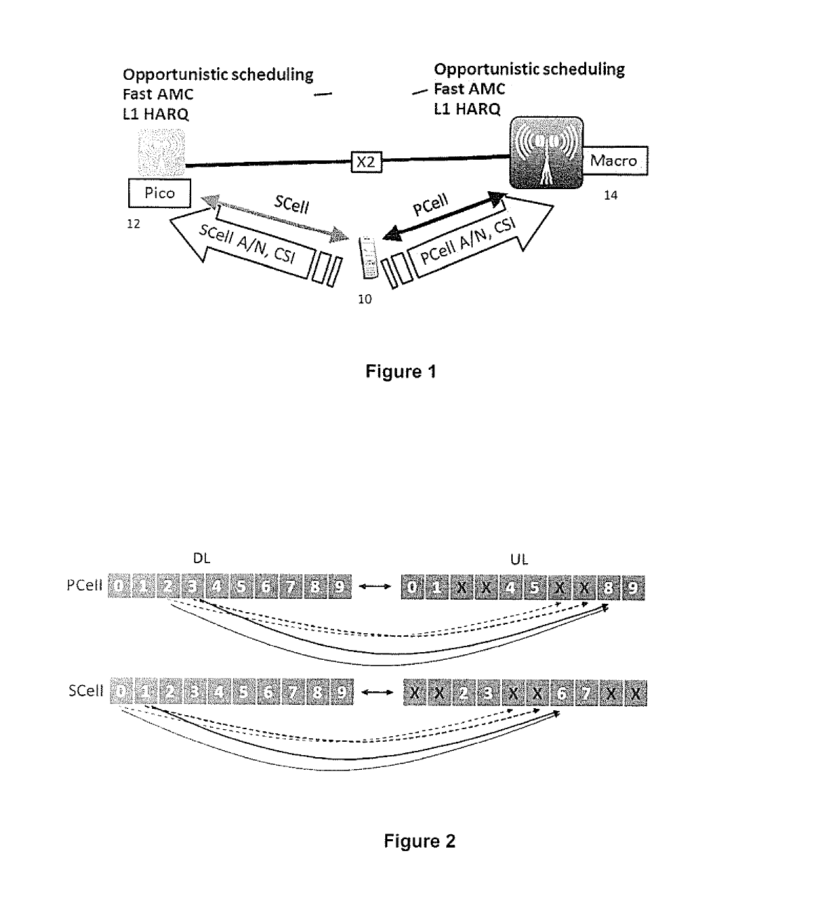

The arrangement in the table above is assumed for FIG. 3 which uses only four DL PDSCH subframes for a given multiplexing window. At the top row of FIG. 3 the UE receives the assignment indication expressed as three PAI bit values (0, 0), (1, 0) and (1, 1) from the above table. Mapping these to the DL subframes in the multiplexing window 350 in the SCell as shown at the top row of FIG. 3 shows that there is a correspondence to subframes 300, 302 and 303. These PAT values 0, 2, and 3 (taken from the above table) are not consecutive and so the UE knows that one DL subframe allocation is missed, and from mapping the PAIs to the DL subframes it knows which one of its allocated PDSCH subframes is missed, subframe 301. This missing allocation will be in that same multiplexing window 350, and will also map to the UE's discontinuous transmission (DTX) period which tells it when to send the ACKs/NACKs on the PUSCH. Since there are four DL subframes scheduled in this window, the UE will generate four ACK/NACK bits for signaling UL on the single UL subframe of the PUSCH mapped from this multiplexing window 350, either as a single codeword or after spatial bundling. Assuming three ACKs and one NACK, the eNB does not know whether subframe 301 was missed by the UE or simply incorrectly decoded, but it matters not since the eNB (the pico eNB 12 in the FIG. 1 environment) will simply retransmit the NACK'd DL subframe 301.

The example at the middle row of FIG. 3 finds the UE receiving assignment indications implemented as PAI bit values (0, 0), (0, 1), (1, 0), which yield values 0, 1 and 2. The last DL subframe in the multiplexing window 360 is subframe 313 which corresponds to PAI value-2. Since the PAI values are consecutive the UE knows that only three subframes 310, 311 and 313 are scheduled for it in this multiplexing window 360; subframe 312 is simply not allocated by the eNB to this UE in this multiplexing window 360. The UE then generates three ACK/NACK bits in case of a single codeword or after spatial bundling and sends them on the PUSCH of the SCell in the single UL subframe (PUSCH on the SCell) which maps from this multiplexing window 360.

In the final example at the lower row of FIG. 3 the UE receives assignment indications implemented as three bit-pairs of PAIs (0, 0), (0, 1) and (1, 0), same as the second row example above. Like that example these yield PAT values 0, 1, 2 which are consecutive. But unlike the second row, in the third row the highest PAI value which the UE did receive does not map to the last DL subframe 323 in the multiplexing window 370, and so the UE is not sure whether the last subframe 323 has been scheduled for it or not. The UE has consecutive PAI values corresponding to subframes 320, 321 and 322 so it knows positively that those DL subframes are allocated to it, but does not know if the remaining last subframe 323 is a missed subframe or is not allocated to the UE.

In order to avoid any misunderstanding between the (pico) eNB and the UE in this example, in one embodiment the UE can map the last subframe 323 of the multiplexing window 370 to DTX and generate four ACK/NACK bits in case of single codeword or after spatial bundling. Assuming the UE sends an ACK for each of sub frames 320, 321 and 323 and a NACK only for the last subframe 323 of which it is unsure is missed or not scheduled, the (pico) eNB will ignore that NACK if it did not allocate that last subframe 323 to this UE or otherwise re-transmit that last subframe 323 if the (pico) eNB did allocate it and the UE missed that allocation. While there is only a 1% probability of the example at the lower row of FIG. 3 occurring it still needs to be resolved for a sufficiently reliable (low BLER) wireless system.

The general steps of one exemplary embodiment are summarized below using the node designators from FIG. 1:
a) The macro eNB 14 uses RRC signaling to inform the UE 10 when it is configured in inter-site carrier aggregation.
b) The pico eNB 12 transmits the PDSCH on the SCell and reuses the TPC bits as a PAI contained in the corresponding PDCCH according to the current PDSCH subframe number within the multiplexing window numbered from 0 to (window size-I). As in the example noted above, this PDCCH will schedule only the SCell and will be transmitted on the SCell by the pico eNB 12.
c) The UE 10 receives this PDCCH and tries to detect whether it contains a DL grant message. If so, the UE 10 shall read the PAI value and try to receive the corresponding PDSCH which is on the SCell.
d) The UE 10 then sorts all the received PAI values within the current multiplexing window and detects whether any subframe corresponding to a PAI is missed, and maps the missed DL subframe to DTX.
e) The UE 10 generates the ACK/NACK bits within the multiplexing window according to the predetermined ACK/NACK codebook size and transmits them to the pico eNB 12 on the PUSCH of the SCell.

Exemplary embodiments of the invention as detailed in the above exemplary embodiments provide the following technical features. They establish a mapping from the PAI to the PDSCH subframes which lie within one multiplexing window, thereby enabling the UE to easily detect whether one PDSCH subframe is missed or not. The specific embodiments detailed above which re-use the TPC bits not increase the size of the downlink control information as compared to conventional LTE, yet still having no impact on the uplink power control.

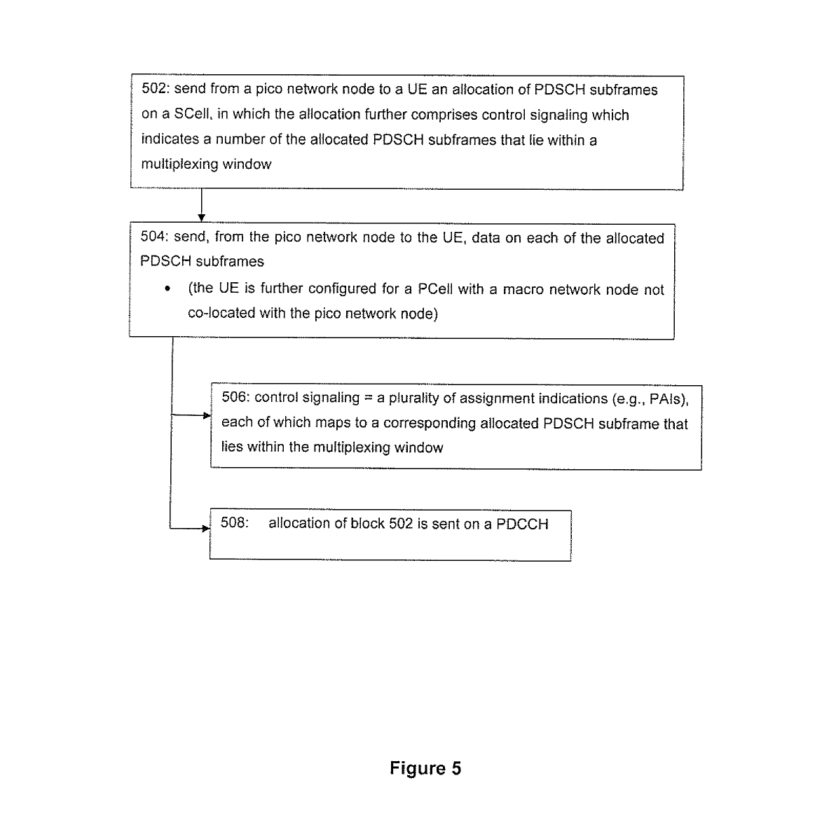

FIGS. 4-5 are flow diagrams illustrating for a specific embodiment those actions taken by the UE and by the (pico) eNB respectively. First consider FIG. 4 from the UE's perspective. At block 402 the UE 10 determines from control signaling a number of PDSCH subframes within a multiplexing window that are allocated for a UE. Then at block 404 the UE checks the determined number against PDSCH subframes the UE has received within the multiplexing window in order to detect whether or not it's missed any downlink subframe within the multiplexing window which is allocated to it. Block 404 also notes that the control signaling and the downlink subframes are received on a SCell from a pico network node and the user equipment is also configured for a PCell with a macro network node not co-located with the pico network node.

Other portions of FIG. 4 detail modifications to or implementation details for blocks 402 and 404; these other functional blocks may be implemented individually or in any combination for specifying any particular embodiment. Block 406 simply states that the control signaling of block 402 is received by the UE on a PDCCH.

Block 408 details the specific embodiment detailed for FIG. 3. Block 408 specifies that the control signaling of block 402 comprises a plurality of assignment indications; and that the checking at block 404 is implemented as mapping each separate assignment indication to a corresponding PDSCH subframe in the multiplexing window. And block 408 adds the additional steps involved with sending the ACKs and NACKs; the UE sends on the SCell to the pico eNB in a single uplink subframe: a) an ACK for each of the PDSCH subframes which were received within the multiplexing window and correctly decoded; and b) a NACK for any allocated PDSCH subframe within the multiplexing window which the UE detected to have been missed or which the UE received but failed to properly decode. While not specifically within FIG. 4, in the example for FIG. 3 each of the separate assignment indications noted at block 410 is exactly two bits, and the single uplink subframe is on a PUSCH. In one embodiment those two bits are obtained by reusing TPC bits contained in a DCI for PUCCH power control. In another embodiment those two bits are newly added bits in a DCI.

Turning to FIG. 5 there is a flow diagram illustrating an exemplary method, and actions taken by the pico eNB according to the exemplary embodiments detailed above. At block 502 Pico eNB sends to a UE an allocation of DL subframes on a SCell, in which the allocation further comprises a control signaling which indicates a number of the allocated PDSCH subframes that lie within a multiplexing window. At block 504 data is sent on each of the allocated PDSCH subframes from the Pico eNB to the UE. In this case the UE is further configured for PCell with Macro eNB not co-located with the Pico eNB.

Block 506 summarizes the examples described above with respect to FIG. 3. The control signaling that indicates the number of the allocated PDSCH subframes comprises a plurality of assignment indications (e.g., PAIs), each of which maps to a corresponding allocated PDSCH subframe which lies within the multiplexing window. In those examples each of the assignment indications is exactly two bits.

Block 508 summarizes the above examples in which the allocation of DL subframes and the control signaling is sent on a PDCCH on the SCell

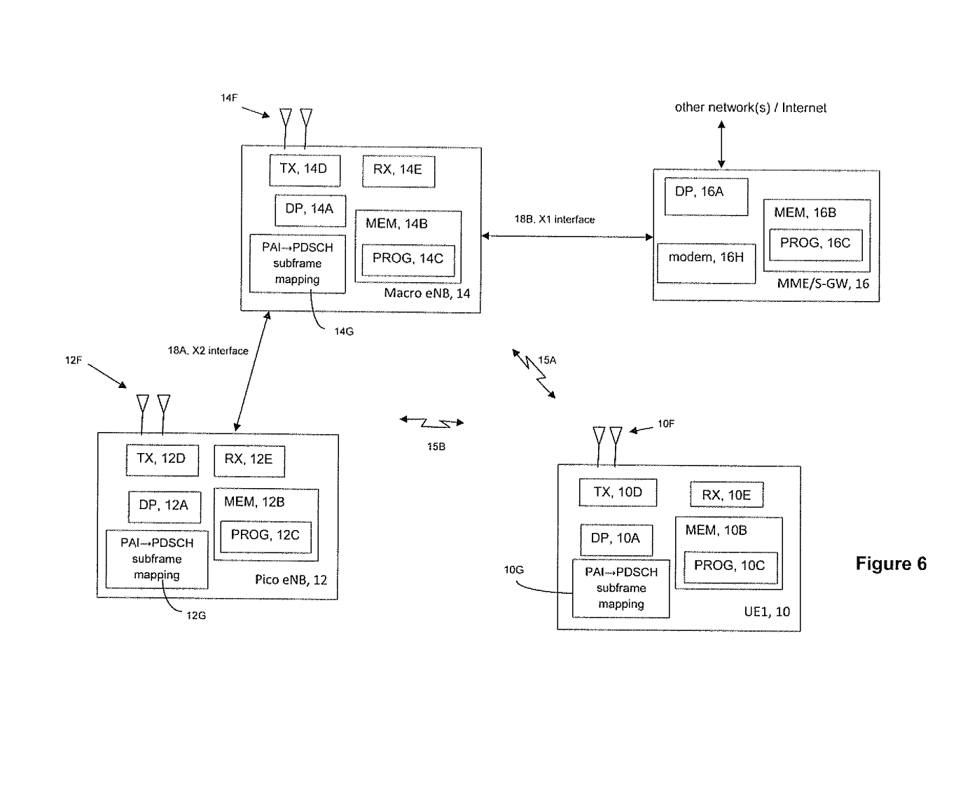

Embodiments of the present invention as detailed at FIGS. 4-5 and further detailed above may be implemented in tangibly embodied software, hardware, application logic or a combination of software, hardware and application logic. In an exemplary embodiment, the application logic, software or an instruction set is maintained on any one of various conventional computer-readable media. The methods represented by FIGS. 4-5 may be performed via hardware elements, via tangibly embodied software executing on a processor, or via combination of both. A program of computer-readable instructions may be embodied on a computer readable memory such as for example any of the MEMs detailed below with respect to FIG. 6.

Reference is now made to FIG. 6 for illustrating a simplified block diagram of various electronic devices and apparatus that are suitable for use in practicing the exemplary embodiments of this invention. In FIG. 6, a wireless network is adapted for communication over a wireless link 15A, 15B with an apparatus, such as a mobile communication device which is referred to above as a UE 10, via a first network access node designated by example at FIG. 6 as a macro eNB 14 and also a second network access node designated by example for the case of an LTE or LTE-A network. There is further an X2 interface 18A between these eNBs 12, 14. The wireless network may include a network control element 16 that may be a mobility management entity MME having serving gateway S-GW functionality such as that known in the LTE system, and which provides connectivity with a further network such as a telephone network and/or a data communications network (e.g., the Internet).

The UE 10 includes a controller, such as a computer or a data processor (DP) 10A, a computer-readable memory (MEM) 10B that tangibly stores a program of computer instructions (PROG) 10C, and at least one suitable radio frequency (RF) transmitter 10D and receiver 10E for bidirectional wireless communications with the eNBs 12, 14 via one or more antennas 10F. The UE 10 has functionality shown at 10G to map between the received PAIs to the DL subframes of the PDSCH on the SCell so as to determine whether there is a missed DL subframe which is allocated to the UE as detailed by example above.

The pico eNB 12 also includes a controller, such as a computer or a data processor (DP) 12A, a computer-readable memory (MEM) 12B that tangibly stores a program of computer instructions (PROG) 12C, and at least one suitable RF transmitter 12D and receiver 12E for communication with the UE 10 via one or more antennas 12F.

The pico eNB 12 has functionality at block 12G similar to that of the UE at block 10G for mapping between the PAIs and the subframes of the PDSCH which are allocated to the UE in a given frame. The pico eNB 12 needs this for the case the DL subframes on the SCell are allocated by a PDCCH which the pico eNB sends itself on the SCell.

The macro eNB 14 also includes a controller, such as a computer or a data processor (DP) 14A, a computer-readable memory (MEM) 14B that tangibly stores a program of computer instructions (PROG) 14C, and at least one suitable RF transmitter 14D and receiver 14E for communication with the UE 10 via one or more antennas 14F. The macro eNB 14 has functionality at block 14G similar to that of the UE at block 10G for mapping between the PAIs and the subframes of the PDSCH which are allocated to the UE in a given frame. The macro eNB 14 is additionally coupled via a data/control path 18B (shown as an X1 interface) to the MME/S-GW 16.

The MME/S-GW 16 also includes a controller, such as a computer or a data processor (DP) 16A and a computer-readable memory (MEM) 16B that stores a program of computer instructions (PROG) 16C. The MME/S-GW 16 may be connected to additional networks such as the Internet.

The techniques herein may be considered as being implemented solely as computer program code embodied in a memory resident within the UE 10 or within either or both eNBs 12, 14 (e.g., as PROG 10C, 12C or 14C, respectively), or as a combination of embodied computer program code (executed by one or more processors) and various hardware, including memory locations, data processors, buffers, interfaces and the like, or entirely in hardware (such as in a very large scale integrated circuit). Additionally, the transmitters and receivers 10D/E, 12D/E and 14D/E may also be implemented using any type of wireless communications interface suitable to the local technical environment, for example, they may be implemented using individual transmitters, receivers, transceivers or a combination of such components.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B, 12B and 14B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising:
at least one processor; and
at least one memory including computer program code,
in which the at least one memory and the computer program code are configured, with the at least one processor, to cause the apparatus at least to:
determine from control signaling a number of physical downlink shared channel PDSCH subframes within a multiplexing window that are allocated for a user equipment; and
check the determined number against PDSCH subframes received within the multiplexing window to detect whether or not any allocated PDSCH subframe within the multiplexing window is missed;
wherein the control signaling and the corresponding PDSCH subframe are received on a secondary cell SCell from a pico network node and the user equipment is also configured for a primary cell PCell with a macro network node not co-located with the pico network node.

2. The apparatus according to claim 1, in which the control signaling is received on a physical downlink control channel PDCCH.

3. The apparatus according to claims 1, in which:
the control signaling comprises a plurality of assignment indications;
checking the determined number against the PDSCH subframes received within the multiplexing window comprises mapping each of the assignment indications to a corresponding PDSCH subframe in the multiplexing window; and
the at least one memory and the computer program code are configured, with the at least one processor, to cause the apparatus to further send on the SCell in a single uplink subframe:
an acknowledgement for each of the PDSCH subframes which were received within the multiplexing window and correctly decoded; and
a negative acknowledgment for any allocated PDSCH subframe within the multiplexing window which was detected to have been missed or which was not correctly decoded.

4. The apparatus according to claim 3, in which each of the separate assignment indications is exactly two bits and the single uplink subframe is on a physical uplink shared channel.

5. The apparatus according to claim 4, in which the two bits are obtained by reusing transmission power control TPC bits contained in a downlink control indication DCI for physical uplink control channel PUCCH power control.

6. The apparatus according to claim 4, in which the two bits are obtained by newly added bits in a downlink control indication DCI.

7. The apparatus according to claim 1, in which the apparatus comprises the user equipment.

8. A method comprising:
determining from control signaling a number of physical downlink shared channel PDSCH subframes within a multiplexing window that are allocated for a user equipment; and
checking the determined number against PDSCH subframes received within the multiplexing window to detect whether or not any allocated PDSCH subframe within the multiplexing window is missed;
wherein the control signaling and the PDSCH subframes are received on a secondary cell SCell from a pico network node and the user equipment is also configured for a primary cell PCell with a macro network node not co-located with the pico network node.

9. The method according to claim 8, in which the control signaling is received on a physical downlink control channel PDCCH.

10. The method according to claims 8, in which:
the control signaling comprises a plurality of assignment indications;
checking the determined number against the PDSCH subframes received within the multiplexing window comprises mapping each of the assignment indications to a corresponding PDSCH subframe in the multiplexing window; and
the method further comprises sending on the SCell in a single uplink subframe:
an acknowledgement for each of the PDSCH subframes which were received within the multiplexing window and correctly decoded; and
a negative acknowledgment for any allocated PDSCH subframe within the multiplexing window which was detected to have been missed or which was not correctly decoded.

11. The method according to claim 10, in which each of the separate assignment indications is exactly two bits and the single uplink subframe is on a physical uplink shared channel.

12. The method according to claim 11, in which the two bits are obtained by reusing transmission power control TPC bits contained in a downlink control indication DCI for physical uplink control channel PUCCH power control.

13. The method according to claim 11, in which the two bits are obtained by newly added bits in a downlink control indication DCI.

14. The method according to claim 8, in which the method is executed by the user equipment.

15. An apparatus comprising:
at least one processor; and
at least one memory containing computer program code, in which the at least one memory and the computer program code are configured, with the at least one processor, to cause the apparatus at least to:
send to a user equipment an allocation of physical downlink shared channel PDSCH subframes on a secondary cell SCell, in which the allocation further comprises control signaling which indicates a number of the allocated PDSCH subframes that lie within a multiplexing window; and
send to the user equipment data on each of the allocated PDSCH subframes;
wherein the user equipment is further configured for a primary cell PCell with a macro network node not co-located with the apparatus.

16. The apparatus according to claim 15, in which the apparatus is a pico eNB.

17. The apparatus according to claims 15, in which:
the control signaling comprises a plurality of assignment indications, each of which maps to a corresponding allocated PDSCH subframe which lies within the multiplexing window.

18. The apparatus according to claim 17, in which each of the separate assignment indications is exactly two bits which are obtained by reusing transmission power control TPC bits contained in a downlink control indication DCI for physical uplink control channel PUCCH power control.

19. The apparatus according to claim 17, in which each of the separate assignment indications is exactly two bits which are obtained by newly added bits in a downlink control indication DCI.

20. The apparatus according to claim 17, in which:
the allocation of PDSCH subframes and the control signaling is sent on a physical downlink control channel PDCCH on the SCell; and
the data is sent on the PDSCH on the SCell.
